(19) United States
(12) Patent Application Publication
(10) Pub. No.: US 2015/0213556 A1
(43) Pub. Date: Jul. 30, 2015

(54) Systems and Methods of Predicting Vehicle Claim Re-Inspections

(71) Applicant: CCC INFORMATION SERVICES, Chicago, IL (US)

(72) Inventor: John Laurence Haller, JR., Kenilworth, IL (US)

(73) Assignee: CCC INFORMATION SERVICES, Chicago, IL (US)

(21) Appl. No.: 14/168,327

(22) Filed: Jan. 30, 2014

(51) Int. Cl. G06Q 40/08

(52) U.S. Cl. CPC G06Q 40/08

(57) ABSTRACT

Techniques for determining or predicting re-inspection of a vehicle insurance claim are disclosed. The probability of an occurrence of a re-inspection of a claim (e.g., a re-inspection score) is determined by using a predictive re-inspection model generated based on a data analysis of historical claim data from a plurality of sources. The re-inspection score may be determined prior to a repair facility initially reviewing the claim or viewing the damage to the vehicle, e.g., at FNOL. Inputs to the predictive re-inspection model may include a settlement estimate, and optionally one or more other claim attributes that are strongly correlated to re-inspection. Other re-inspection information may be additionally or alternatively predicted by using the predictive re-inspection model. Candidate claims for re-inspection may be identified by ranking re-inspection scores and/or other re-inspection information.

### CROSS-REFERENCE TO RELATED APPLICATIONS

This application is related to U.S. patent application Ser. No. 12/792,104, entitled “SYSTEMS AND METHODS OF PREDICTING VEHICLE CLAIM COST” and filed on Jun. 2, 2010, the entire disclosure of which is hereby incorporated by reference herein. This application is also related to U.S. Pat. No. 8,095,391, entitled “SYSTEM AND METHOD FOR PERFORMING REINSPECTION IN INSURANCE CLAIM PROCESSING” and issued on Jan. 10, 2012, the entire disclosure of which is hereby incorporated by reference herein. Additionally, this application is related to U.S. patent application Ser. No. ______ (Attorney Docket No. 29856-48216), entitled “SYSTEM AND METHOD OF PREDICTING A VEHICLE CLAIM SUPPLEMENT BETWEEN AN INSURANCE CARRIER AND A REPAIR FACILITY” and filed concurrently herewith, the entire disclosure of which is hereby incorporated by reference herein.

### FIELD OF THE DISCLOSURE

The present disclosure generally relates to identifying vehicle insurance claims for re-inspection, and in particular, determining a likelihood of an occurrence of a re-inspection of a vehicle insurance claim.

### BACKGROUND

When an insured vehicle is damaged and a vehicle insurance claim is made, typically a repair facility employee or a representative of the insurance company or carrier (e.g., an adjustor, assessor, or other agent) assesses the damage and generates a cost estimate for repairing the vehicle. This preliminary cost estimate is provided to or used by a repair facility that is to perform the repair work. In many cases, upon performing its own inspection of the vehicle or upon tearing down the vehicle, the repair facility finds additional damage that was not identified in the estimate provided by the insurance carrier, as, for example, the repair facility is able to further access the vehicle and perform a more thorough examination than could an adjustor who generally writes estimates based only on damages he or she can see, discern, or identify first-hand. When damages and/or costs that were not indicated in the estimate are discovered, the repair facility requests additional monies or a supplement from the insurance carrier corresponding to the newly identified damages and/or costs. In some situations, the insurance carrier agrees to the supplement amount straightaway, and in some situations, the insurance carrier negotiates with the repair facility to agree on a set of authorized additional repairs and an amount of the supplement to cover the additional repairs. For some claims, more than one supplement may be requested during the claim resolution process, for example, when still additional damage is uncovered, when replacement parts are difficult to find, and for other reasons. Accordingly, the total cost to settle a claim at the insurance carrier and the repair facility interface (e.g., the final settlement or the agreed-to amount that is to be paid by the insurance carrier to the repair facility) is based on the estimate amount and one or more supplement amounts.

In addition to settlements, another aspect of the insurance carrier/repair facility interface is re-inspection. “Re-inspection,” as used herein, generally refers to a process of auditing and evaluating the accuracy, quality, and timeliness of claim estimates and appraisals during the claims resolution process. Typically, a subset of all claims serviced by the repair facility is identified, by one or more human re-inspectors, for re-inspection. In most scenarios, the re-inspectors review the identified claims with respect to cost, claim cycle time, accuracy of supplement estimates, limitations, discounts, and/or other criteria by using a re-inspection score sheet or checklist An example of a re-inspection process is described in aforementioned, commonly owned U.S. Pat. No. 8,095,391, the entire disclosure of which is incorporated by reference herein.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Methods, apparatuses and systems for identifying vehicle insurance claims for re-inspection are disclosed. The identification of particular claims for re-inspection may be based on, for example, settlement estimates of the claims and/or other claim attribute data. Generally, a vehicle insurance claim corresponds to a vehicle that is covered by an insurance policy provided by an insurance carrier or company, and at least some of the vehicle damage that is indicated in or with the vehicle insurance claim is to be repaired by one or more repair facilities. Accordingly, a “final settlement” between an insurance carrier and a repair facility (which is referred to interchangeably herein as a “final settlement amount,” “final settlement cost,” “settlement,” “settlement amount,” or “settlement cost”), as used herein, generally refers to an actual monetary amount that the insurance carrier finally provides (or agrees to provide) to the repair facility for performing specific repairs that are indicated with the vehicle insurance claim or to the claimant to compensate for the damage. That is, once the final settlement of a vehicle insurance claim is determined and agreed to by the insurance carrier and the repair facility at some point during the claim resolution process, the final settlement remains constant or unchanged for the remainder of the claim resolution process. Accordingly, a “settlement estimate” (which is also referred to interchangeably herein as a “final settlement estimate,” an “estimate of a settlement” or an “estimate of a final settlement”), as used herein, generally refers to an estimate, of the final settlement amount, that is generated during an earlier stage of the claim resolution process, e.g., at First Notice of Loss (FNOL), prior to the repair facility being initially notified of the vehicle insurance claim, prior to the repair facility examining the damage to the vehicle, after a re-inspection, prior to the repair facility repairing the vehicle, or at any stage of the claim resolution process prior to the final settlement amount being agreed to by the insurance company and the repair facility.

During the claim resolution process, typically the repair facility provisionally agrees to or approves a settlement estimate, but then, as a next step in the process, the repair facility performs its own (and usually a more thorough) inspection of the vehicle damages or initiates tear down of the vehicle for repair. For some claims, additional repair work and/or costs are discovered by the repair facility's inspection, e.g., due the use of more sophisticated tools than are available to an insurance assessor, due to the ability to take apart sections of the vehicle to view previously hidden damage, due to necessary substitution of more expensive parts when parts indicated with the estimate are unavailable, and for other reasons. A supplement corresponding to the additional repair work and/or costs may be negotiated between the insurance company and the repair facility. As used herein, the term “supplement” (which is also interchangeably referred to herein as a “supplement amount” or a “supplement cost”) generally refers to an additional monetary amount or cost of additional repair work that was not indicated in a previous settlement estimate of the vehicle insurance claim. When a supplement is agreed to by the insurance company and the repair facility, the insurance carrier agrees to provide the additional monetary amount above and beyond the previous settlement estimate. In some cases, multiple supplements are added to the claim over time during the claim resolution process.

Accordingly, in some scenarios, the final settlement amount of a vehicle insurance claim is determined based on an initial estimate or another estimate performed early during the claim resolution process, and is also based on one or more supplements that are added and agreed upon after the estimation. For example, the final settlement amount of a vehicle insurance claim may be based on a sum of the initial estimate and all additional supplements.

“Re-inspection” or “reinspection,” as used herein, generally refers to the process of auditing and evaluating the accuracy, quality, and timeliness of claim estimates and appraisals during the claims resolution process. In some cases, the re-inspection process also includes auditing the accuracy, quality, and timeliness of the performance of the assessor, the appraiser, and/or the repair facility, e.g., against pre-determined or set criteria defined by the insurance company. Typically, an insurance company initiates the re-inspection process. In some scenarios, a re-inspection may result in a revised settlement estimate that is greater than or less than a previous settlement estimate.

An example method of identifying vehicle insurance claims for re-inspection is disclosed. The method includes obtaining a settlement estimate of a vehicle insurance claim, and providing the settlement estimate as an input into a predictive re-inspection model to predict the likelihood or a probability that the vehicle insurance claim will require a re-inspection at some time during the claims resolution process. An indication of the likelihood or probability of an occurrence of a re-inspection of the vehicle insurance claim is referred to herein as a “re-inspection score” or a “re-inspection score” of the vehicle insurance claim. In an embodiment, the predictive re-inspection model is generated based on a machine learning or predictive data analysis of historical vehicle claim data that includes re-inspection data which, in some cases, is obtained from multiple insurance carriers and other sources. The method additionally includes providing an indication of the re-inspection score to a user interface and/or to a recipient computing device.

An example method of identifying vehicle insurance claims for re-inspection includes configuring a memory of a computing device with computer-executable instructions for generating a predictive re-inspection model. The computer-executable instructions are executable (e.g., by a processor of the computing device) for performing a data analysis (e.g., a machine learning or predictive analysis) on claim data corresponding to a plurality of historical vehicle insurance claims (which, in some cases, are obtained from a plurality of insurance carriers and other claim data sources). The claim data may include settlement estimates of the plurality of historical vehicle insurance claims; indications of whether or not one or more re-inspections were performed; costs of performing the re-inspections; supplement amounts corresponding to occurred re-inspections; additional repair work and/or other costs indicated by the re-inspections; respective actual, final settlement amounts of the plurality of historical vehicle insurance claims; and a plurality of other vehicle claim attributes of the plurality of historical vehicle insurance claims. The method further includes determining, based on the data analysis, a set of independent variables of the predictive re-inspection model, where the set of independent variables is a subset of the plurality of claim attributes that are more strongly correlated to an occurrence of a re-inspection and/or to a magnitude of a financial benefit (e.g., a profit) of the re-inspection than are other claim attributes. Still further, the method includes executing the computer-executable instructions to generate the predictive re-inspection model.

The method also includes determining, using the generated predictive re-inspection model, a re-inspection score for a vehicle insurance claim. In an embodiment, a settlement estimate corresponding to the vehicle insurance claim is input into or provided to the predictive re-inspection model to generate the re-inspection score. In some cases, one or more claim attributes of the vehicle insurance claim that are included in the subset of the plurality of claim attributes that are more strongly correlated to occurrences of re-inspections are also input into or provided to the predictive re-inspection model.

An example apparatus for identifying vehicle insurance claims for re-inspection includes a computing device particularly configured to identify vehicle insurance claims for re-inspection. The computing device includes at least one tangible, non-transitory computer storage medium (such as a memory or other suitable device) storing computer-executable instructions thereon, and the computer-executable instructions are executable by a processor to obtain a settlement estimate for a particular vehicle insurance claim. The computer-executable instructions are further executable to cause the obtained settlement estimate to be input into or otherwise provided to a predictive re-inspection model to determine a re-inspection score for the claim, where the re-inspection score indicates the statistical likelihood of an occurrence of a re-inspection of the claim. The predictive re-inspection model used to determine the re-inspection score is generated from a machine learning or predictive data analysis performed on a plurality of claim attributes of a plurality of vehicle insurance claims, for example.

### BRIEF DESCRIPTION OF THE DRAWINGS

FIG. 1 is a block diagram of an exemplary system for determining a re-inspection score of a vehicle insurance claim;

FIG. 2 is an example data flow in an exemplary system configured to determine a re-inspection score for a vehicle insurance claim using a predictive re-inspection model;

FIG. 3 illustrates the system of FIG. 2 communicatively connected to an exemplary system configured to estimate an amount of a settlement between an insurance carrier or company and a repair facility for a vehicle insurance claim;

FIG. 4 illustrates an example method of determining or predicting an occurrence of a re-inspection for a vehicle insurance claim;

FIG. 5 illustrates an example method of predicting or determining an occurrence of a re-inspection for a vehicle insurance claim; and

FIG. 6 illustrates an example method of identifying vehicle insurance claims for re-inspection.

### DETAILED DESCRIPTION

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents. As used herein, the term “vehicle” may include a car, an automobile, a motorcycle, a truck, a recreational vehicle, a van, a bus, a boat or other amphibious vessel, heavy equipment, or any other insurable mode of transportation.

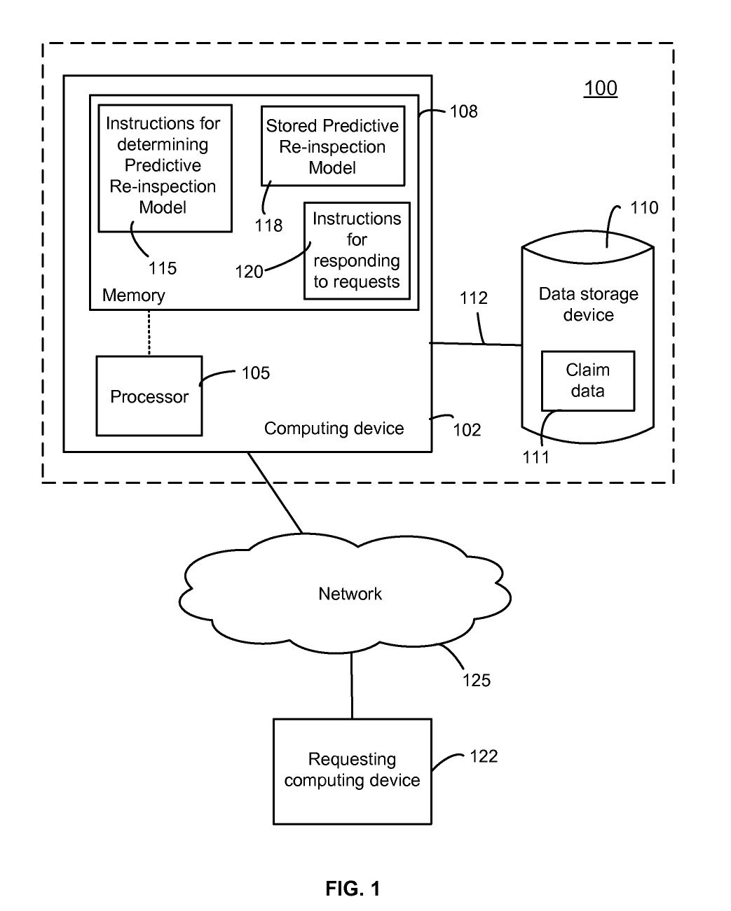

FIG. 1 is a block diagram of an exemplary system 100 for predicting an occurrence of a re-inspection for a vehicle insurance claim. The system 100 includes a computing device 102, which for the sake of illustrating the principles described herein is shown as a simplified block diagram of a computer. However, such principles apply equally to other electronic devices, including, but not limited to, cellular telephones, personal digital assistants, wireless devices, tablets, smart phones or devise, media players, appliances, gaming systems, entertainment systems, set top boxes, and automotive dashboard electronics, to name a few. In some embodiments, the computing device 102 may be a server or a network of computing devices, such as a public, private, peer-to-peer, cloud computing or other known network.

The computing device 102 includes at least one processor 105 and at least one non-transitory, tangible computer-readable storage media or device 108, such as a memory. The computing device 102 may be a single computing device 102, or may be a plurality of networked computing devices. In some cases, the computing device 102 is associated with an insurance carrier. In some cases, the computing device 102 is associated with a repair facility. In some cases, the computing device 102 is associated with a third party that is not an insurance carrier (e.g., does not directly sell or issue insurance policies) and that is not a repair facility (e.g., does not perform vehicle repairs), but may be in communicative connection with a computing device associated with the insurance carrier and/or with a computing device associated with a repair facility.

As shown in FIG. 1, the computing device 102 is operatively connected to a data storage device 110 via a link 112. The data storage device 110 may be a single storage device, or may be one or more networked data storage devices. Although FIG. 1 illustrates the data storage device 110 as being separate from the computing device 102, in some embodiments the data storage entity 110 may be contained within the same physical entity as the computing device 102. The link 112 may be as simple as a memory access function, or it may be a wired, wireless, or multi-stage connection through a network. Many types of links are known in the art of networking and may be contemplated for use in the system 100.

The data storage device 110 includes or stores claim data 111, such as claim data related to historical vehicle insurance claims from one or more insurance companies or carriers and/or from other sources such as repair shops, body shops, accident report databases, etc. Each data point in the claim data 111 corresponds to a particular vehicle insurance claim and includes one or more types of information corresponding to the claim, such as a final claim settlement cost, vehicle owner or insured information, and vehicle attribute information (e.g., make, model, odometer reading, etc.). The different types of information or data that may be stored for a vehicle insurance claim are generally referred to interchangeably herein as “vehicle insurance claim attributes,” “vehicle claim attributes,” “vehicle claim parameters,” “claim attributes,” “claim parameters,” or “claim data types.” A particular data point included in the claim data 111 may correspond to a partial or a total loss claim. For a partial loss claim, typically the vehicle was repaired by one or more repair facilities, and thus the corresponding data point may include information corresponding to an initial repair estimate, a final settlement amount between the insurance company and one of the repair facilities, types and costs of replacement parts, labor costs, a location of the repair facility, and the like. Other types of claim data that may be included for the data point are an indication as to whether or not a supplement was generated for the claim, and if a supplement was generated, the monetary amount of the supplement. The claim data point may include an indication of whether or not a re-inspection occurred for the claim, and if a re-inspection did occur, the cost of performing the re-inspection (e.g., cost to the insurance carrier and/or cost to the repair facility), and the differential between an estimate that occurred after the re-inspection and an estimate performed prior to the re-inspection (e.g., an estimate performed at First Notice of Loss (FNOL) or other estimate). For a total loss claim, such as when a vehicle was stolen or was totaled, the corresponding data point may include information such as a location of vehicle loss and an amount of a payment from the insurance carrier to the insured.

A list of types of claim data information, parameters or attributes that may be included in the claim data 111 follows:
Insurance policy number
Insurance company or carrier holding the insurance policy
Identification of insured party
Vehicle owner name; street, city and state address; zip code
State and zip code where vehicle loss occurred
Zip code where vehicle is garaged
Vehicle driver name; age; street, city and state address; zip code
Vehicle Identification Number (VIN)
Vehicle make, model, model year, country of origin, manufacturer
Vehicle type or body style (e.g., sedan, coupe, pick-up, SUV, wagon, van, hatchback, convertible, etc.)
Vehicle odometer reading
Vehicle engine size, color, number of doors
Whether or not the vehicle is leased
Age of vehicle
Condition of vehicle
Settlement amount between insurance company and repair facility
Payout amount (if any) to insured party or party holding the insurance policy
Loss date
Vehicle appraisal inspection location and responsible adjustor
Primary and secondary point of impact
Vehicle drivable condition
Airbag deploy condition
Vehicle dimension score
Vehicle repair score
Initial estimate
Estimate or prediction of settlement at FNOL
Estimate from another repair facility or party
One or more additional estimates and indications of when during the claim settlement process the additional estimates occurred
Occurrence of one or more re-inspections
Cost to perform each re-inspection
Revised estimate after re-inspection and corresponding repair work/parts
Occurrence of one or more supplements paid from insurance company to repair facility
Monetary amount of each supplement
Level of desired target quality of repair
Level of actual quality of repair
Deductible
Towing and storage costs
Labor hours and costs for replacement and/or repair, and
Type of labor (e.g., sheet metal, mechanical, refinish, frame, paint, structural, diagnostic, electrical, glass, etc.)
Type of replacement part (e.g., OEM (Original Equipment Manufactured), new, recycled, reconditioned, etc.)
Cost of replacement part
Paint costs
Tire costs
Hazardous waste disposal costs
Repair facility name, location, state, zip code
Drivability indicator

Some of the claim parameters or claim attributes of claim data points are vehicle parameters that are indicative of attributes of a vehicle. Some claim parameters or attributes are indicative of attributes of a driver, an owner, or an insured party of the vehicle, and some claim parameters or attributes may pertain to the insurance policy itself. It is understood that not every data point or vehicle claim in the claim data 111 is required to include every claim attribute in the list above. Some data points or vehicle claims in the claim data 111 may include claim attributes that are not on the list.

Turning back to FIG. 1, the memory 108 of the computing device 102 comprises non-transitory, tangible computer-readable storage media, such as, but not limited to RAM (Random Access Memory), ROM (Read Only Memory), EEPROM (Electrically Erasable Programmable Read-Only Memory), flash memory or other memory technology, CD (Compact Disc)-ROM, digital versatile disks (DVD) or other optical disk storage, magnetic cassettes, magnetic tape, magnetic disk storage or other magnetic storage devices, biological memories or data storage devices, or any other medium which can be used to store desired information and which can be accessed by the processor 105. In some embodiments, the memory 108 may include more than one computer-readable storage media device and/or device type.

The memory 108 includes computer-executable instructions 115 stored thereon for determining a predictive re-inspection model 118. The predictive re-inspection model 118 includes one or more independent variables, one or more dependent variables, and one or more mappings between values of the one or more independent and dependent variables. In the system 100 for predicting a re-inspection, the one or more independent variables that are input into the predictive re-inspection model 118 to determine values of the dependent variables may include an estimate of a final settlement amount (e.g., a settlement estimate) of the vehicle insurance claim. The dependent variables of the predictive re-inspection model 118 may include a variable indicative of whether or not a re-inspection is predicted to occur for a particular vehicle insurance claim, and/or a variable indicative of a predicted financial profit or loss if the re-inspection is performed (e.g., based on a predicted cost of the re-inspection and/or on predicted changes to the settlement estimate).

To determine the predictive re-inspection model 118 and the one or more dependent variables, the one or more other independent variables, and the one or more mappings between dependent and independent variables included therein, the computer-executable instructions 115 may include instructions for obtaining claim data 111 corresponding to a plurality of historical vehicle insurance claims (e.g., vehicle insurance claims that have been made and settled) from the data storage device 110. The historical claim data 111 includes, for a plurality of historical vehicle claims, at least some of the parameters or claim attributes listed above, and/or may include other claim attributes. In particular, the historical claim data 111 may include data indicative of whether or not a re-inspection was generated, the number of generated re-inspections for a particular claim, the costs to perform any generated re-inspections, the differences in repair work and/or parts discovered by the re-inspection as compared to a previous estimate, a target level of repair quality, an actual level of repair quality, and/or an amount of the final settlement between the repair facility and the insurance carrier. Obtaining the claim data 111 from the data storage device 110 may include performing a database read or some other database access function, or may include initiating a message exchange between the computing device 102 and the data storage device 110. In some embodiments, obtaining the claim data 111 may include obtaining all claim attribute values for a particular data point. In some embodiments, obtaining the claim data includes obtaining a subset of all parameter or claim attribute values that are available for the particular data point.

The computer-executable instructions 115 for determining the predictive re-inspection model 118 may include instructions for performing a data analysis on the obtained claim data 111 to determine a subset of the plurality of claim parameters that are most closely correlated to an occurrence of a re-inspection and/or to a magnitude of an amount of a financial profit or loss of performing a re-inspection across the claim data 111. The data analysis may be, for example, a linear regression analysis, a multivariate regression analysis such as the Ordinary Least Squares algorithm, a logistic regression analysis, a K-th nearest neighbor (k-NN) analysis, a K-means analysis, a Naïve Bayes analysis, another suitable or desired predictive data analysis, one or more machine learning algorithms, or some combination thereof.

The computer-executable instructions 115 are executable to identify a subset of the plurality of parameters that are most closely correlated to a re-inspection of a claim across the claim data 111 as the independent variables of the predictive re-inspection model 118. In an embodiment, the settlement estimate amount is an independent variable of the predictive re-inspection model 118. Additionally or alternatively, in some situations, one or more other claim attributes are independent variables of the predictive re-inspection model 118.

A total number of independent variables may be configurable or selectable. For example, the total number of independent variables may be limited to include only parameters that have a t-statistic greater than a certain threshold, where the t-statistic is a measure of how strongly a particular independent variable explains variations in a dependent variable. Additionally or alternatively, the total number of independent variables may be limited to include parameters that have a P-value lower than another threshold, where the P-value corresponds to a probability that a given independent variable is statistically unrelated to a dependent variable.

Still further, the total number of independent variables may be additionally or alternatively limited based on an F-statistic, where the F-statistic evaluates an overall statistical quality of the predictive re-inspection model 118 with multiple independent variables. For example, all of the determined independent variables may be initially included in the predictive re-inspection model 118, and those independent variables with lower t-statistics may be gradually eliminated until the F-statistic for the predictive re-inspection model 118 increases to a desired level. Of course, the number of independent variables may be additionally or alternatively configured based on other statistical or non-statistical criteria as well, such as user input.

The computer-executable instructions 115 include instructions for determining the one or more mappings between values of the independent variables and the dependent variables of the predictive re-inspection model 118. For example, values (or ranges thereof) of the parameters or attributes determined to be independent variables may be mapped to values (or ranges thereof) of a probability of a re-inspection occurrence and/or a predicted financial loss or financial benefit or profit of performing a re-inspection. In some embodiments, different values or ranges of values of the independent variables may be grouped or segmented for manageability purposes.

In some embodiments of the system 100, the instructions 115 for determining the predictive re-inspection model 118 may include instructions for performing a cluster analysis on the claim data 111 prior to performing the predictive data analysis. A cluster analysis may be performed to whittle the plethora of candidate independent variables represented within the claim data 111 down to a manageable or desired number of clusters, so that a similarity between data points within a cluster is maximized and a similarity between various clusters is minimized. For example, a cluster analysis of vehicle models included in the claim data 111 based on impact location may be performed, resulting in a set of clusters of vehicle insurance claims where the claims in each cluster are most closely interrelated based on the portion of the vehicle that received the primary impact in a collision. In another example, a clustering of vehicle insurance claims based on a percentage of replacements parts that are OEM (Original Equipment Manufactured) may be performed, resulting in a different set of vehicle insurance claim clusters, where the vehicle insurance claims in each cluster of the different set are most closely interrelated based on a percentage of OEM replacement parts used to repair the vehicle. Other example of clustering based on other claim attributes may be possible. The cluster analysis may be performed by any known clustering algorithm or method, such as hierarchical clustering, disjoint clustering, the Greenacre method (e.g., as described in Greenacre, M. J. (1988), “Clustering Rows and Columns of a Contingency Table,” Journal of Classification, 5, pp. 39-51), or portions, variations or combinations thereof.

The number of clusters obtained from a cluster analysis may be configurable or selectable. For example, a desired number of clusters may be based on user input. Additionally or alternatively, the desired number of clusters may be based on a desired level of similarity or dissimilarity between clusters. Other bases for configuring the number of clusters are also possible.

After the predictive re-inspection model 118 (including independent variables, dependent variables, and mappings) is determined by the instructions 115, the predictive re-inspection model 118 may be stored in the memory 108. Alternatively or additionally, some or all portions of the predictive re-inspection model 118 may be stored in the data storage device 110 or at another suitable data storage entity.

In FIG. 1, the memory 108 includes further computer-executable instructions 120 stored thereon for receiving, from a requesting computing device 122, a request to determine a re-inspection score for a particular vehicle insurance claim, e.g., a score that is indicative of a probability of an occurrence of a re-inspection of the particular vehicle insurance claim. In some embodiments (not shown), the computer-executable instructions 115 and 120 may both be included in a single set of instructions, but in FIG. 1 they are shown as separate entities 115, 120 for clarity of discussion.

Furthermore, in FIG. 1, although the requesting entity is illustrated as a requesting computing device 122, this is only exemplary, as the requesting entity may be another type of entity such as a human who interacts with the system 100 via a local or remote user interface. In the embodiment shown in FIG. 1, the requesting computing device 122 is communicatively coupled to the computing device 102 via a network 125. The network 125 may be, for example, a private local area network, a wide area network, a peer-to-peer network, a cloud computing network, the Internet, a wired or wireless network, or any combination of one or more known public and/or private networks that enable communication between the computing devices 122 and 102. In some embodiments, the network 125 may be omitted, such as when the computing device 122 and the computing device 102 are directly connected or are an integral computing device.

In some scenarios, the requesting computing device 122 may be a tablet, laptop, smart device, server, or other computing device that is associated with, owned or operated by the insurance company. For example, the requesting computing device 122 may be a tablet, laptop, or smart device used by a field assessor while the assessor is at a field site inspecting vehicle damage, e.g., at FNOL. In other examples, the requesting computing device 122 is a back-end computing server or network of computing devices of the insurance company that processes all incoming claims, or the requesting computing device 122 is a host of a web site that agents of the insurance company are able to access via a browser.

Returning to the memory 108, the further computer-executable instructions 120 stored thereon may be executable to receive the request, from the requesting computing device 122, for the re-inspection score for the particular vehicle insurance claim. The request may include a multiplicity of claim attribute or parameter values, such as a settlement estimate; data corresponding to the insurance policy covering the damaged vehicle identified in the particular vehicle claim (e.g., deductible, identifications of authorized repair facilities, etc.); data specific to the particular vehicle, such as a VIN (Vehicle Identification Number); a desired level of repair quality; and/or other data indicative of attributes of the particular vehicle insurance claim. The request may take any known form, such as a message, a data transfer, or a web-service call.

From the specific claim data included in the request, values that correspond to the particular vehicle insurance claim for some or all of the independent variables of the predictive re-inspection model 118 may be determined by the instructions 120, and may be provided as inputs to the predictive re-inspection model 118. When a request does not reference valid values for all independent variables of the predictive re-inspection model 118, the instructions 120 may attempt to provide a best fit. For example, the instructions 120 may ignore independent variables for which no or an invalid value was provided in the request, or the instructions 120 may assign a default value for those independent variables. In some cases, particular claim attributes are provided as inputs to the predictive re-inspection model 118 irrespective of whether or not they are or are not independent variables of the predictive re-inspection model 118. For example, a settlement estimate and/or a target level of repair quality may be provided as inputs to the predictive re-inspection model 118.

The computer-executable instructions 120 determine a re-inspection score for the vehicle insurance claim based on the inputs and on the mappings of the predictive re-inspection model 118, and may return an indication of the re-inspection score to the requesting computing device 122. For example, the computer-executable instructions 120 may cause one or more claim attribute values of the vehicle insurance claim to be input into the predictive re-inspection model 118, which then generates, as an output, a re-inspection score for the vehicle insurance claim. The re-inspection score, as previously discussed, indicates a statistical likelihood or a probability that a re-inspection will occur for the particular vehicle insurance claim, as the predictive re-inspection model 118 generating the re-inspection score is itself generated based on a predictive data analysis of (or machine learning algorithm performed on) historical claim data to determine the conditions or claim attribute values that are strongly correlated with actual re-inspection occurrences. The generation of the predictive re-inspection model 118 is further detailed in another section.

Thus, in view of the many aspects and features of the system 100, a user of the system 100 is able to utilize the re-inspection score to quickly, and in a cost-efficient manner, identify candidate claims for re-inspection. Rather than examining all claims, or examining select claims for re-inspection that have been crudely identified by applying a simple score sheet or checklist to each of the claims, the re-inspection score, which is statistically based on a sophisticated data analysis of claim attributes of a plethora of historical vehicle insurance claims from multiple sources, may be used. For example, if a re-inspection score of a particular claim is lower than a threshold (that has been automatically determined or that has been set by the user), the user may automatically approve the particular claim without incurring any additional costs to identify and evaluate the claim for re-inspection, and without performing a potentially needless re-inspection. Furthermore, with the system 100, the user is able to better control potential costs of performing re-inspections by using the re-inspection scores and or the predictive re-inspection model 118. In some scenarios, the user may select the re-inspection score threshold to realize different business goals. For example, the user may select thresholds based on stringency of jurisdictional regulations and/or based on business relationships with particular repair facilities.

In some embodiments, the computer-executable instructions 120 determine a potential cost or benefit of performing a re-inspection for a particular vehicle insurance claim. In an example, the computer-executable instructions 120 first determine an amount of a predicted supplement to a settlement estimate of the particular vehicle insurance claim. The amount of the predicted supplement to the particular vehicle insurance claim may be determined using the techniques described in aforementioned U.S. patent application Ser. No. ______ (Attorney Docket No. 29856-48216), entitled “SYSTEM AND METHOD OF PREDICTING A VEHICLE CLAIM SUPPLEMENT BETWEEN AN INSURANCE CARRIER AND A REPAIR FACILITY,” or by using other techniques. The computer-executable instructions 120 then determine a predicted cost of performing the re-inspection, e.g., by inputting selected claim attribute values into the predictive re-inspection model 118. The predictive re-inspection model 118 returns a predicted cost of performing a re-inspection of the particular vehicle insurance claim, and computer-executable instructions 120 compare the predicted cost and the predicted supplement to determine the potential cost and/or benefit (e.g., expected loss and/or expected profit) of performing the re-inspection of the claim.

In any event, the re-inspection score, the potential cost and/or benefit of performing the re-inspection, and any other predicted re-inspection information for the particular vehicle insurance claim may be provided to a user interface and/or to another computing device, such as the requesting computing device 122.

In some embodiments, the instructions 115 for determining a predictive re-inspection model 118 may include instructions for determining a weighting of independent variables commensurate with the strength of their respective correlation to one or more dependent variables. In these embodiments, the further instructions 120 may determine the re-inspection score based on the weighting of values of the independent variables for the particular vehicle insurance claim. For example, if a particular set of authorized repair facilities is found (via the data analysis) to be more strongly correlated to re-inspection benefit than is the odometer reading of the damaged vehicle, the instructions 120 may give priority to fitting an indication of the candidate repair facilities to independent variable values (or ranges thereof) over fitting the odometer reading of the damaged vehicle.

In some embodiments, the predictive re-inspection model 118 stored in the system 100 may be trained or updated to account for additional claim data (e.g., additional vehicle claim data) that has been added to the claim data 111. Training or updating may be triggered periodically at a given interval, such as weekly, monthly or quarterly. Training or updating may be triggered when a particular quantity of additional data points has been added to the original claim data 111. In some embodiments, prior to training, some portion of the original claim data 111 may be deleted, such as older labor cost data that no longer accurately reflects labor market wages. Additionally or alternatively, training or updating may be triggered by a user request.

When a trigger to update the predictive re-inspection model 118 is received by the system 100, the system 100 may perform some or all of the instructions 115 to re-determine at least a portion of the predictive re-inspection model 118 based on the additional claim data or a new set of claim data. The re-determination may operate on only the additional claim data, or may operate on an aggregation of one or more portions of the original claim data 111 and the additional claim data. The re-determination may include repeating some or all of the steps originally used to determine the original predictive re-inspection model 118 on the additional claim data. For example, the re-determination may include performing predictive analytics on the additional claim data to determine if the additional claim data statistically supports revising the independent variables of the predictive re-inspection model 118. In another example, the re-determination may include performing cluster analysis on the aggregation of the additional claim data and at least a portion of the original claim data to determine a revised segmentation. The exact set of steps to be repeated on the additional claim data may be selectable, and/or may vary based on factors such as a quantity of additional data points, time elapsed since the last update, a user indication, or other factors. The re-determination may result in an updated predictive re-inspection model 118, which then may be stored in the system 100.

Note that the predictive re-inspection model 118 generated by the system 100, and in particular, updates to the predictive re-inspection model 118 may result in a more statistically accurate reflection of identities and values of independent variables, and thus more accurate re-inspection scores estimates over time. As re-inspection scores increase in their statistical accuracy, users of the system 100 are able to realize significant cost savings. For example, as re-inspection scores become more statistically accurate, a user of the system 100 gains more trust in the predictive accuracy of the scores. Accordingly, rather than manually using checklists or score sheets to crudely determine claims for re-inspection which may or may not result in a financial profit, the user is able to determine a threshold re-inspection score, automatically funnel all claims above (or below) the threshold score to be re-inspected, and have confidence that this funneling will result in desired financial gains. As such, over time, the overall number of re-inspections that are performed will decrease, thus resulting in cost savings to both the insurance companies and the repair facilities.

Additionally, although FIG. 1 illustrates both the instructions 115 for determining a predictive re-inspection model 118 and the instructions for responding to requests 120 being stored on and executed by the same computing device 102, in some embodiments, the two sets of instructions 115, 120 may be stored on and executed by different computing devices or systems that may be in communicative connection with each other. Further, in some scenarios, the computing device 102 may be associated with, owned or operated by the insurance company that issued the policy under which the damaged vehicle is covered. For example, the computing device 102 may be a back-end server or network of computing devices of the insurance company that stores and executes the instructions 120 for responding to requests, and may be in communicative connection with another computing device (not shown) that stores and executes the instructions 115 for determining the predictive re-inspection model 118.

In some scenarios, the computing device 102 may be associated with, owned or operated by a third party that is not the insurance company that issued the policy under which the damaged vehicle is covered, and is not one of the repair facilities that is to repair the vehicle damages. For example, the computing device 102 may be associated with a company or organization that provides predictive products and resources to multiple insurance companies, repair facilities, and other companies or entities associated with repairing damages to insured vehicles.

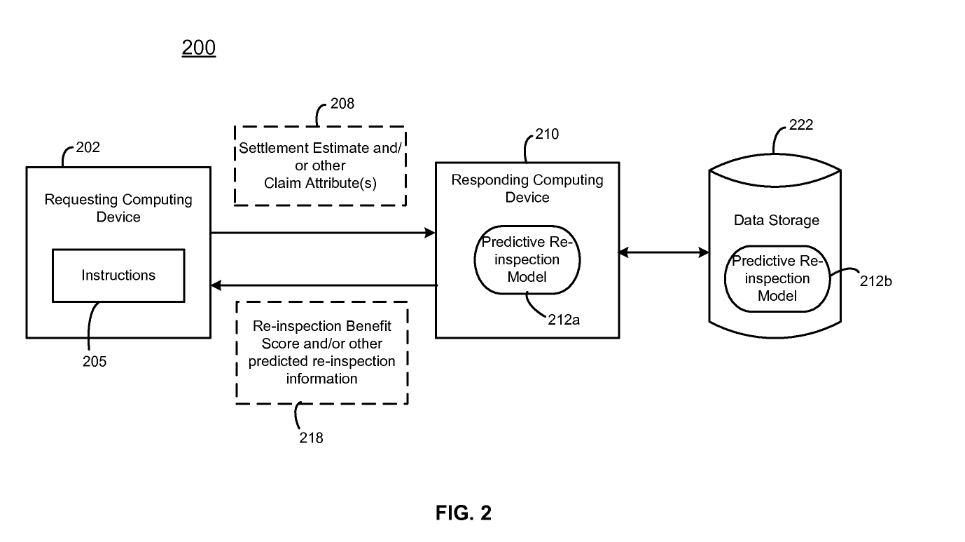

FIG. 2 depicts an exemplary data flow in an embodiment of a system 200 that includes a computing device 202 particularly configured to determine or predict re-inspection information for a vehicle insurance claim based on a predictive re-inspection model. The computing device 202 may be a general purpose computing device with a memory, a processor, and computer-executable instructions 205 stored on its memory and executable by its processor. The computing device 202 may operate in conjunction with embodiments of the system 100 of FIG. 1, and in some embodiments, the computing device 202 may be the requesting computing device 122 of FIG. 1.

The instructions 205 stored on the computing device 202 include instructions for obtaining values of claim attributes or parameters of a vehicle insurance claim for which predicted re-inspection information (e.g., an occurrence of a re-inspection, a re-inspection score, a financial profit or loss of performing a re-inspection, a cost of re-inspection, and/or other re-inspection information) is desired. The values may be obtained via a user interface, by reading from a file, by extracting from a message, or by any other known means of obtaining values. The obtained values may correspond to any claim parameter or combination of parameters, such as those included in the previously discussed list or other claim parameters. In some embodiments, the obtained claim parameters include an estimate of a final settlement amount of the vehicle insurance claim, and in some embodiments, additional or alternative claim parameter values are obtained. Obtaining the values of claim parameters may be limited to obtaining only the values of specific claim parameters that have been determined to be independent variables of a predictive re-inspection model 212, for example, such as when a user interface prompts a user to enter only the specific claim parameters corresponding to the independent variables, or when the instructions 205 automatically extracts values of only the desired specific claim parameters.

The instructions 205 further include instructions for obtaining, based on the values of the obtained claim parameters and based on the predictive re-inspection model 212, an indication of whether or not a re-inspection of the vehicle insurance claim is predicted to occur, (e.g., a re-inspection score for the vehicle insurance claim) as determined by the predictive re-inspection model 212. Additionally or alternatively, the instructions 205 further include instructions for obtaining, based on the values of the obtained claim parameters, an indication of an amount of a predicted financial profit or loss if the re-inspection is performed, an amount of a predicted cost of re-inspection for the vehicle insurance claim, and/or other predicted re-inspection information, as determined at least in part by the predictive re-inspection model 212. In the system 200, obtaining the re-inspection score, the predicted profit or loss of re-inspection, the predicted cost of re-inspection, and/or other predicted re-inspection information may include the computing device 202 making a request 208 of another computing device 210 that is particularly configured to access a predictive re-inspection model 212a and/or 212b. The requesting 202 and the responding 210 computing devices may be directly or remotely connected via one or more public and/or private networks. In some embodiments of the system 200, the requesting computing device 202 and the responding computing device 210 have a client/server relationship. In some embodiments, the computing devices 202 and 210 have a peer-to-peer or cloud computing relationship, or the computing devices 202 and 210 are an integral computing device. Other relationships between the computing devices 202 and 210 are also possible. Thus, the request 208 may take any known form, such as sending a message, transferring data, or performing a web-service call.

In FIG. 2, the system 200 includes a data storage device 215 that is accessible by the responding computing device 210. Similar to FIG. 1, the predictive re-inspection model 212a, 212b may be partially or entirely stored on the computing device 210 and/or on the data storage device 215.

The request 208 may include a value of the settlement estimate of the vehicle insurance claim. The request 208 may additionally or alternatively include one or more other claim attributes of the vehicle insurance claim. In some embodiments, the values of only the claim attributes that have been determined to be independent variables of the predictive re-inspection model 212a, 212b are included in the request 208.

The responding computing device 210 determines the predicted re-inspection information for the vehicle insurance claim based on one or more claim attribute values (which may or may not include a settlement estimate) and the predictive re-inspection model 212a, 212b. For example, one or more of the claim attribute values included in the request 208 are input into the predictive re-inspection model 212a, 212b. Similar to the system 100 of FIG. 1, if the request 208 omits or provides an invalid value for a particular claim attribute that is an independent variable of the predictive re-inspection model 212a, 212b, the computing device 210 may process the request 208 based on a best fit of the provided values in the request 208. The responding computing device 210 returns, to the requesting computing device 202, an indication 218 of the re-inspection score, the predicted profit or loss due to re-inspection, the predicted cost of re-inspection, and/or other predicted re-inspection information for the vehicle insurance claim.

As such, the requesting computing device 202 obtains the indications 218 of the predicted re-inspection information from the responding computing device 210, and may cause at least some of the indications 218 of the predicted re-inspection information to be presented at a user interface (e.g., of the requesting computing device 202 or of another computing device). In some embodiments, the requesting computing device 202 causes at least some of the indications 218 of the predicted re-inspection information to be transmitted to another computing device.

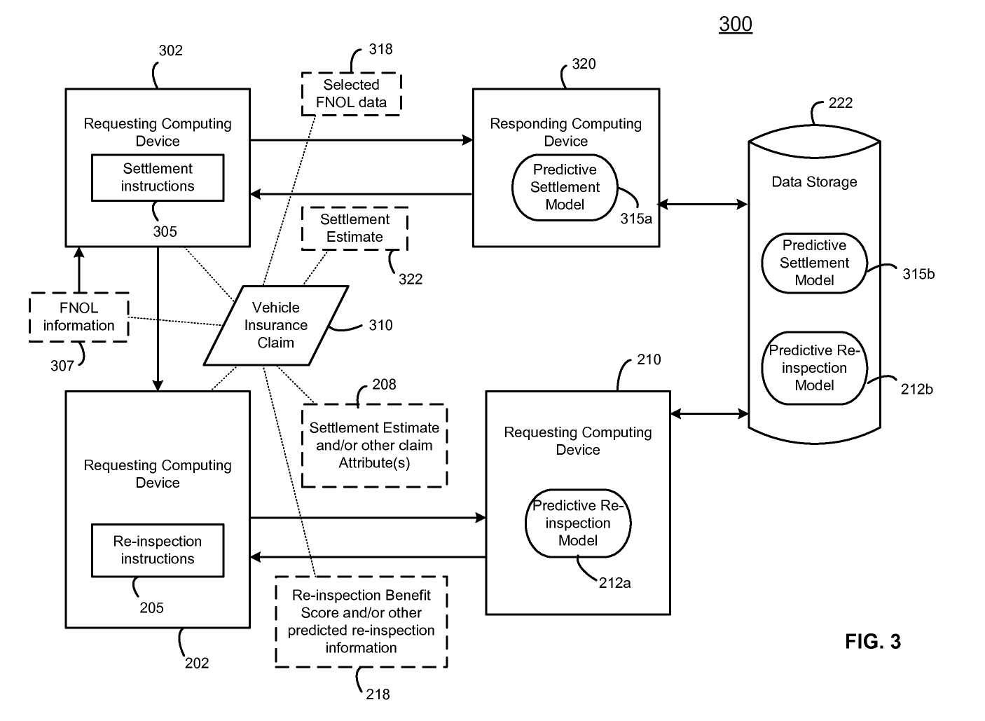

FIG. 3 depicts an exemplary data flow in an embodiment of a system 300 that includes a computing device 302 configured to estimate, based on a predictive settlement model, a settlement between an insurance carrier or company and a repair facility for a vehicle insurance claim, and configured to provide the settlement estimate to the system 200 of FIG. 2 for determining predicted information associated with a possible or potential re-inspection of the claim. The computing device 302 may be a general purpose computing device with a memory, a processor, and computer-executable instructions 305 stored on its memory and executable by its processor. Additionally, the system 300 includes or is in communicative connection with the computing device 202 of the system 200. In some embodiments, the computing device 302 and the computing device 202 are the same computing device (e.g., an integral computing device having both instructions 205 and 305). Additionally or alternatively, the computing device 302 may operate in conjunction with embodiments of the system 100 of FIG. 1. In some embodiments, the computing device 302 is the requesting computing device 122 of FIG. 1.

The system 300 may determine the settlement estimate of the vehicle insurance claim at any time during the claims resolution process prior to a time at which the re-inspection score and/or other re-inspection information is determined. For example, the system 300 may determine the settlement estimate prior to the repair facility being initially notified of the vehicle insurance claim, prior to the repair facility examining the damage to the vehicle, prior to the repair facility provisionally approving a settlement estimate, prior to the repair facility repairing the vehicle, or at any stage of the claim resolution process prior to the final settlement amount being determined and agreed to, and/or at First Notice of Loss (FNOL). As previously discussed, an FNOL is generally known in the art as a first point of contact with an insurance carrier or company where information is collected to determine whether or not a claim corresponding to an insured vehicle is to be filed and, if needed, to determine an estimated timeframe for finalizing disposition or resolution of the claim. The embodiment illustrated by FIG. 3 shows the computing device 302 as a computing device or system via which an FNOL for an insured vehicle is processed. An example of such a system may be found in U.S. patent application Ser. No. 12/792,104, entitled “SYSTEMS AND METHODS OF PREDICTING VEHICLE CLAIM COST” and filed on Jun. 2, 2010, the entire disclosure of which is hereby incorporated by reference herein. However, it is understood that the configuration shown in FIG. 3 is exemplary only, and is not meant to be limiting.

In FIG. 3, the instructions 305 stored on the computing device 302 include instructions for obtaining incident data 307 corresponding to the FNOL of the insured vehicle. Typically, the incident data 307 may be obtained via a user interface, however, the incident data 307 may also be obtained by reading from a file, by extracting from a message, by performing an automatic analysis of photos or other images, or by any other known means of obtaining incident data. The incident data 307 may include values for any number of claim attributes or parameters from the previously discussed list, or other parameters. The incident data 307 is associated with a particular vehicle insurance claim 310 whose data and information may be captured, for example, in a data file or as an entry stored in a computing system of the insurance carrier.

The instructions 305 further include instructions for obtaining, based on the incident data 307, an indication of an estimate of a final settlement between the insurance carrier and a repair facility for the vehicle insurance claim, as determined by a predictive settlement model 315. In the system 300, to obtain the indication of the settlement estimate, the computing device 302 requests 318 another computing device 320 that is particularly configured to access a predictive settlement model 315a and/or 315b to provide the settlement estimate. The requesting and the responding computing devices 302 and 320 may be directly or remotely connected via one or more private and/or public networks. In some embodiments of the system 300, the requesting computing device 302 and the responding computing device 320 have a client/server relationship. In some embodiments, the computing devices 302 and 320 have a peer-to-peer relationship or cloud computing relationship, or the computing devices 302, 320 are an integral computing device. Other relationships between the computing devices 302 and 320 are also possible. Thus, a request 318 may take any known form, such as sending a message, transferring data, or performing a web-service call. In some embodiments, the responding computing device 320 and the responding computing device 210 may be the same computing device (e.g., an integral computing device able to access both the settlement model 315 and the re-inspection model 212).

In some cases, the responding computing device 320 and a data storage device 222 storing the predictive settlement model 315 that is accessible by the responding computing device 320 are an embodiment of the computing device 102 and the data storage device 110 of FIG. 1. Similar to FIG. 1, the predictive settlement model 315a, 315b may be partially or entirely stored on the computing device 320 and/or on the data storage device 222.

Additionally, FIG. 3 illustrates the data storage device 222 as an integral data storage device storing both the settlement model 315b and the re-inspection model 212b. However, in some embodiments, the settlement model 315b and the re-inspection model 212b are stored in separate data storage devices. Indeed, in some embodiments, the settlement model 315b and the re-inspection model 212b are an integral predictive model so that both a settlement estimate and predicted re-inspection information are generated by the integral predictive model based on a same set of claim attribute values that are input into the integral predictive model. For instance, for a particular vehicle claim and its set of claim attributes, the integral predictive model generates a settlement amount as well as generates different respective re-inspection scores for different candidate repair facilities.

Returning to the data flow shown in FIG. 3, the request 318 may include at least a portion of the incident data 307, and in particular, may include values of at least some of the claim parameters included in the incident data 307. In some embodiments, the values of only the claim parameters that have been determined to be independent variables of the predictive settlement model 315a, 315b are included in the request 318. In other embodiments, additional incident data is also be included in the request 308, such as a locale corresponding to the FNOL (e.g., a location of an accident, theft, or damage occurrence), a point of impact, one or more damaged parts and the like.

The responding computing device 320 determines an estimate of the final settlement between the insurance carrier and a repair facility for the vehicle insurance claim based on the information provided in the request 318 and based on the predictive settlement model 315a, 315b. The responding computing device 310 returns an indication 322 of settlement estimate, and the settlement estimate 322 may be recorded with the vehicle insurance claim 310, and/or may be provided to or obtained by the system 200.

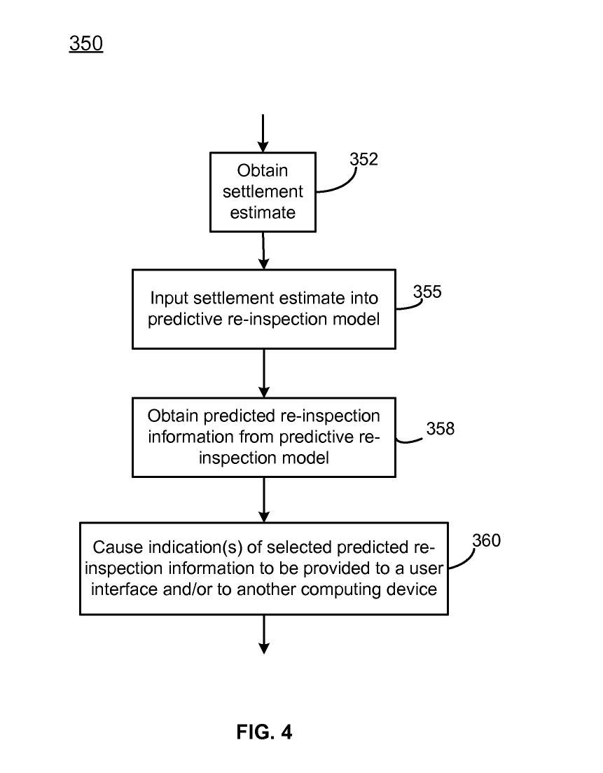

FIG. 4 is an example method 350 of predicting re-inspection for a vehicle insurance claims, such as predicting an occurrence of a re-inspection, a re-inspection score, a financial profit or loss of performing a re-inspection, a cost of re-inspection, and/or other re-inspection information. Embodiments of the method 350 may be used in conjunction with one or more the systems of FIGS. 1-3 and with the previously discussed list of possible claim attributes or parameters, and/or with other claim attributes or parameters. For ease of discussion, and not for limitation purposes, the method 350 is described with simultaneous reference to FIGS. 1-3, although the method 350 may be performed by or in conjunction with systems other than the systems 100, 200 and 300 of FIGS. 1-3.

The method 350 includes a step 352 of obtaining an indication of a settlement estimate of a vehicle insurance claim for a vehicle covered by a vehicle insurance policy issued by an insurance carrier. The settlement estimate may be obtained (block 352) at a computing device 102 of a system 100 configured to predict re-inspection occurrences and other re-inspection information. For example, the settlement estimate may be obtained by electronically receiving the settlement estimate from another computing device, the settlement estimate may be received via a user interface of the computing device 102, or the settlement estimate may be obtained by the computing device 102 itself predicting the settlement estimate (e.g., in embodiments where the computing device 102 is included in the system 300).

The method 350 includes causing the settlement estimate to be input into or provided to a predictive re-inspection model (block 355) that has been generated based on data analysis (e.g., predictive data analysis or machine learning algorithms) performed on historical vehicle insurance claim data (e.g., the predictive re-inspection model 212). The data analysis performed on the historical claim data may be, for example, a linear regression analysis, a multivariate regression analysis such as the Ordinary Least Squares algorithm, a logistic regression analysis, a K-th nearest neighbor (k-NN) analysis, a K-means analysis, a Naïve Bayes analysis, another suitable or desired predictive data analysis, one or more machine learning algorithms, or some combination thereof. The historical vehicle insurance claim data may include partial and total loss vehicle claim data obtained or collected from one or more insurance companies and/or from other sources such as repair shops, body shops, accident report databases, etc. Generally, the claim data corresponds to vehicle insurance claims that have been resolved, and includes values of claim attributes or parameters corresponding to, for example, settlement estimates and associated repairs, whether or not re-inspections were performed, costs of performed re-inspections, additional or reduced repair work discovered by the performed re-inspections, supplement amounts corresponding to performed re-inspections, final settlement amounts, date of claim, identification of one or more repair facilities and their locations, a level of quality of the repairs, any of the claim parameters in the previously discussed list, and/or other claim parameters. In some scenarios, the historical claim data operated on by the data analysis to generate the model (e.g., the predictive re-inspection model 212) is the same set of data operated on by a different data analysis to generate a different model (e.g., the predictive settlement model 315).

The predictive re-inspection model (e.g., the predictive re-inspection model 212) is configured to generate or output, for the vehicle insurance claim, a re-inspection score, a predicted loss or profit if a re-inspection is performed, a predicted cost of performing the re-inspection, and/or other predicted re-inspection information based one or more inputs. The one or more inputs may include the settlement estimate and, optionally, values of one or more other claim attributes that were determined, by the data analysis, to be more strongly correlated to the predicted re-inspection information than are other attributes of vehicle insurance claims. The inputs may also include other claim attributes, such as a target or desired level of quality of repair, a timeliness of repair completion, or other claim attributes or constraints on the claim resolution process.

The method 350 further includes obtaining or receiving one or more indications of at least some of the predicted re-inspection information obtained from the predictive re-inspection model (block 358), and at least some of these indications may be provided to a user interface and/or to another computing device (block 360). In an example, indications of at least some of the predicted re-inspection information are provided to a user interface of the computing device 102 or to a remote user interface (e.g., via a web portal), and/or indications of at least some of the predicted re-inspection information are transmitted to another computing device (e.g., a computing device associated with the insurance carrier). Typically, the indications of at least some of the predicted re-inspection information are provided to the user interface and/or to another computing device prior to a repair facility having knowledge of the existence of the vehicle insurance claim, prior to a repair facility examining the damage to the insured vehicle, prior to the repair facility repairing the vehicle, or prior to the repair facility provisionally approving or agreeing to a settlement estimate. In some cases, the indications of the predicted re-inspection information may be provided at FNOL.

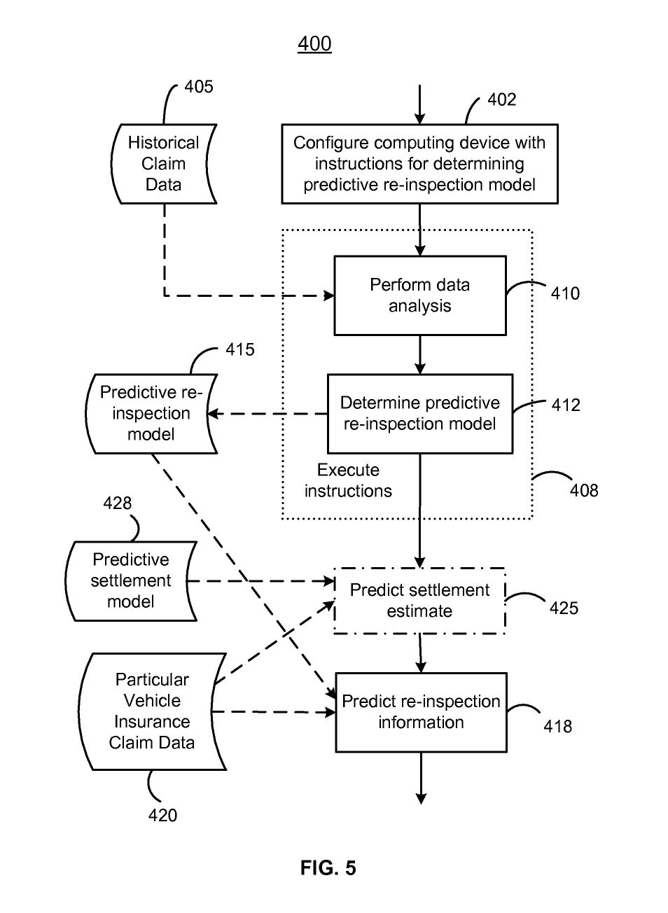

FIG. 5 is an example method 400 of predicting re-inspection for a vehicle insurance claims, such as predicting an occurrence of a re-inspection, a re-inspection score, a financial profit or loss of performing a re-inspection, a cost of re-inspection, and/or other re-inspection information. Embodiments of the method 400 may be used in conjunction with one or more of the systems and methods described with respect to FIGS. 1-4, with the previously discussed list of possible claim attributes or parameters, and/or with other claim parameters. For ease of discussion, and not for limitation purposes, the method 400 is described with simultaneous reference to FIGS. 1-4, although the method 400 may be performed by or in conjunction with systems other than the systems 100, 200 and 300 of FIGS. 1-3 and/or the method of FIG. 4.

The method 400 includes configuring a computing device (block 402) with computer-executable instructions for generating or determining a predictive re-inspection model based on claim data 405 of a plurality of historical vehicle insurance claims. The configuring 402 may include, for example, storing computer-executable instructions on a memory of the computing device, such as the computer-executable instructions 115 of FIG. 1. The claim data 405 may include a multiplicity of claim attributes of the plurality of historical claims such as previously discussed, e.g., settlement estimates and corresponding repairs, whether or not re-inspections were performed, costs of performed re-inspections, additional or reduced repair work discovered by the performed re-inspections, supplement amounts corresponding to performed re-inspections, final settlement amounts, date of claim, identification of one or more repair facilities and their locations, a level of quality of the repairs, any of the claim parameters in the previously discussed list, and/or other claim parameters. Not all types of claim data need to be included for each historical vehicle insurance claim included in the claim data 405.

The method 400 includes executing (block 408), e.g., by a processor of the computing device, the computer-executable instructions that have been configured onto or stored on the computing device (block 402). The execution of the computer-executable instructions may cause the computing device to, for example, perform a data analysis (block 410) on the historical claim data 405. The data analysis may be a linear regression analysis, a multivariate regression analysis such as the Ordinary Least Squares algorithm, a logistic regression analysis, a K-th nearest neighbor (k-NN) analysis, a K-means analysis, a Naïve Bayes analysis, another suitable or desired predictive data analysis, one or more machine learning algorithms, or some combination thereof.

Based on the data analysis, the method 400 may determine or generate (block 412) a predictive re-inspection model 415. In a preferred embodiment, determining or generating the predictive re-inspection model (block 412) includes executing the computer-executable instructions 408 stored on the computing device to determine one or more independent variables, one or more dependent variables, and one or more mappings between values of the one or more independent variables and values of the one or more dependent variables, e.g., in a manner such as previously discussed above. In some embodiments, the determined or generated predictive re-inspection model 415 may be stored and or provided to another computing device or entity.

Additionally, the method 400 includes determining, for a particular vehicle insurance claim, a re-inspection score, a predicted financial profit or loss of performing a re-inspection, a predicted cost of re-inspection, and/or other predicted re-inspection information (block 418) based on the predictive re-inspection model 415 and the values of one or more claim parameters corresponding to the particular vehicle insurance claim 420. In an embodiment, the method 400 maps, based on the predictive re-inspection model 415, the values of claim parameters of the particular vehicle insurance claim 420 that correspond to independent variables to determine the predicted re-inspection information 418, and/or to determine other dependent variables. If the independent variables are weighted in the predictive re-inspection model 415, then the block 418 may weight the values of the parameters 420 corresponding to the particular vehicle claim accordingly. The output of the mapping may include one or more indications of predicted re-inspection information. In some embodiments, the determined output corresponding to re-inspections may be stored, e.g., as part of the particular vehicle claim data 420. The method 400 may include providing the indication of the determined output corresponding to re-inspections to another entity such as a requesting computer or a user interface, in some cases.

Optionally, the method 400 includes predicting a settlement estimate for the particular vehicle insurance claim (block 425), e.g., using a technique such as previously described with respect to FIG. 3. As shown in FIG. 4, predicting the settlement estimate for the particular vehicle insurance claim (block 425) may be performed prior to determining the predicted re-inspection information for the claim (block 418). For example, a settlement estimate may be determined (block 425) for the vehicle insurance claim based on its claim data 420 and a predictive settlement model 428, and the determined settlement estimate may then be provided to determine the predicted re-inspection information (block 418). For some vehicle insurance claims, multiple sequences of estimating the settlement (block 425) and predicting a resulting predicted re-inspection information (block 418) may occur.

Similar to the method 350, the method 400 may include updating the predictive re-inspection model 415 (not shown). In these embodiments, the method 400 receives an indication that additional claim data has been added to the claim data 405, and updates the predictive re-inspection model 415 based on the additional claim data. In some embodiments, the updated predictive re-inspection model may be stored and/or provided to another computing device or entity.

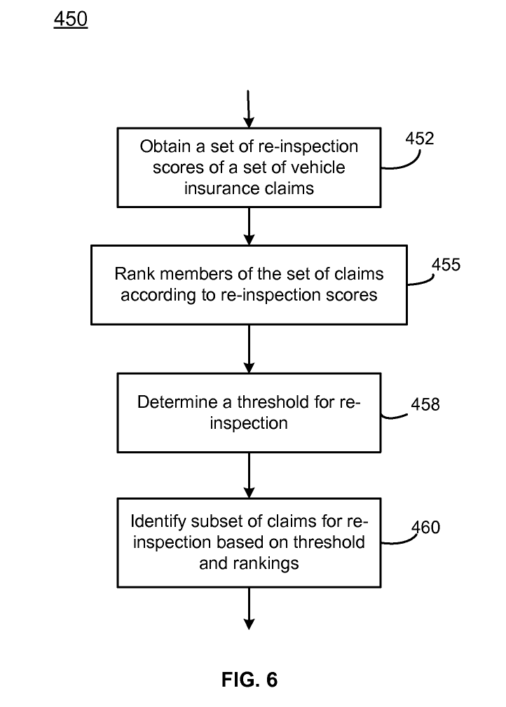

FIG. 6 is an example method 450 of identifying vehicle insurance claims for re-inspection. Embodiments of the method 450 may be used in conjunction with one or more of the systems and methods described with respect to FIGS. 1-5, with the previously discussed list of possible claim attributes or parameters, and/or with other claim parameters. For ease of discussion, and not for limitation purposes, the method 450 is described with simultaneous reference to FIGS. 1-5, although the method 450 may be performed by or in conjunction with systems other than the systems 100, 200 and 300 of FIGS. 1-3 and/or other than the methods described with respect to FIGS. 4 and 5. At least a portion of the method 450 may be performed, for example, by executing computer-executable instructions stored on a computing device associated with an insurance carrier, or stored on a computing device associated with a third party (e.g., that is not an insurance carrier and is not a repair facility) and communicatively connected to a computing device associated with an insurance carrier. In some situations, at least a portion of the method is performed by executing computer-executable instructions stored on one of the computing devices 102, 202, 302, 210 or 320.

In FIG. 6, the method 450 includes obtaining 452, at a computing device, a set of re-inspection scores of a set of vehicle insurance claims, e.g., a set of vehicle insurance claims being serviced by a particular repair facility. As discussed above, a re-inspection score of a vehicle insurance claim is indicative of the likelihood or probability of an occurrence of a re-inspection for the vehicle insurance claim. Re-inspection scores may be generated by, for example, the system 100 of FIG. 1, the method 350 of FIG. 4, or by other systems or methods. Typically, the re-inspection scores are generated by using a predictive re-inspection model generated from a data analysis of claim data from a plurality of historical vehicle claims, such as in a manner similar to that of the method 400. The set of re-inspection scores may be obtained, for example, by electronically receiving the re-inspection scores from another computing device, by receiving the re-inspection scores via a user interface, by the computing device accessing a database or data storage entity, or by the computing device itself determining the re-inspection scores (e.g., when the computing device is included in the system 200).

The method 450 includes ranking 455 the set of claims according to their re-inspection scores. In some cases, the claims are ranked from least likely to have a re-inspection occurrence to most likely to have a re-inspection occurrence, or vice versa. In some cases, the claims are ranked based on the difference between their respective re-inspection score and their respective settlement estimate. In an example, the claims are ranked based on the number of standard deviations that their respective re-inspection score is from the respective settlement estimate (e.g., according to the claim data from the plurality of historical vehicle claims). As such, when a particular re-inspection score is higher than its corresponding settlement estimate, the associated claim has a higher probability for a supplement and may require an additional inspection to re-evaluate the vehicle damages. When a particular re-inspection score is lower than its corresponding settlement estimate, a potential financial benefit to the insurance carrier may be realized for the associated claim.

In some embodiments, members of the set of claims are ranked additionally or alternatively based on other predicted re-inspection information, such as a predicted profit or loss of performing a re-inspection. The one or more criteria by which claims are ranked may be configurable.

Additionally, the method 450 includes determining 458 a threshold for re-inspection, e.g., a re-inspection threshold. The re-inspection threshold may be a level, so that all claims having a re-inspection score greater than or less than the threshold level are identified for re-inspection. In some cases, the threshold for re-inspection may be a percentage, so that a certain threshold percentage of claims serviced by the particular repair facility that are most likely to have a re-inspection occurrence are identified for re-inspection. The re-inspection threshold may be pre-set or pre-determined, and may adjustable according to the business needs, e.g., business needs of the insurance carrier. For example, the threshold may be adjusted so that re-inspection budgets are met, the threshold may be adjusted to drive behavior changes of the particular repair facility, the threshold may be adjusted to identify only those claims for which a re-inspection would be profitable (within any jurisdictional laws or regulations), and/or the threshold may be adjusted for other reasons.

Based on the threshold and the ranking of the set of claims, a subset of the set of claims is identified for re-inspection (block 460). Indications of the identified subset may be provided to a user interface, and/or to another computing device.

Although the disclosure describes example methods and systems including, among other components, software and/or firmware executed on hardware, it should be noted that these examples are merely illustrative and should not be considered as limiting. For example, it is contemplated that any or all of the hardware, software, and firmware components could be embodied exclusively in hardware, exclusively in software, or in any combination of hardware and software. Accordingly, while the disclosure describes example methods and apparatus, persons of ordinary skill in the art will readily appreciate that the examples provided are not the only way to implement such methods and apparatus.

When implemented, any of the computer readable instructions or software described herein may be stored in any computer readable storage medium or memory such as on a magnetic disk, a laser disk, or other storage medium, in a RAM or ROM of a computer or processor, portable memory, etc. Likewise, this software may be delivered to a user, a process plant or an operator workstation using any known or desired delivery method including, for example, on a computer readable disk or other transportable computer storage mechanism or over a communication channel such as a telephone line, the Internet, the World Wide Web, any other local area network or wide area network, etc. (which delivery is viewed as being the same as or interchangeable with providing such software via a transportable storage medium). Furthermore, this software may be provided directly without modulation or encryption or may be modulated and/or encrypted using any suitable modulation carrier wave and/or encryption technique before being transmitted over a communication channel.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention. It is also recognized that the specific approaches described herein represent but some of many possible embodiments as described above. Consequently, the claims are properly construed to embrace all modifications, variations and improvements that fall within the true spirit and scope of the invention, as well as substantial equivalents thereof. Accordingly, other embodiments of the invention, although not described particularly herein, are nonetheless considered to be within the scope of the invention.

1. A method of predicting re-inspection for a vehicle insurance claim, the method comprising:
obtaining, at a first computing device, a settlement estimate of a vehicle insurance claim corresponding to a vehicle covered by an insurance policy provided by an insurance carrier, the settlement estimate based on an inspection of the vehicle and including an estimate of a monetary amount to be paid by the insurance carrier to a repair facility for repairing vehicle damage indicated with the settlement estimate;
causing, by the first computing device, the settlement estimate to be input into a predictive re-inspection model to generate a re-inspection score indicative of a probability of an occurrence of a re-inspection of the vehicle insurance claim, the predictive re-inspection model generated based on historical claim data; and
providing, by the first computing device, an indication of the re-inspection score to at least one of a user interface or to a recipient computing device for determining whether or not a re-inspection of the vehicle insurance claim is warranted.

2. The method of claim 1, wherein:
causing the settlement estimate to be input into the predictive re-inspection model comprises causing the settlement estimate to be input into a linear regression model generated from a regression analysis of historical claim data of a plurality of historical vehicle insurance claims to determine a subset of a plurality of claim attributes that are more strongly correlated to re-inspection occurrences than are other attributes of the plurality of claim attributes; and
the historical claim data includes settlement estimates of the plurality of historical vehicle insurance claims, indications of whether or not re-inspections occurred for the plurality of historical vehicle insurance claims, and a plurality of claim attributes of the plurality of historical vehicle insurance claims.

3. The method of claim 2, wherein the historical claim data further includes indications of respective levels of actual repair quality corresponding to the plurality of historical vehicle insurance claims, and wherein the re-inspection score is generated based on a target level of repair quality for the vehicle.

4. The method of claim 1, wherein causing the settlement estimate to be input into the predictive re-inspection model to generate the re-inspection score comprises causing the settlement estimate and at least a portion of a plurality of claim attributes of the vehicle insurance claim to be input into the predictive re-inspection model to generate the re-inspection score.

5. The method of claim 1, wherein the historical claim data includes claim data corresponding to a plurality of insurance carriers.

6. The method of claim 1, wherein:
the predictive re-inspection model is a first model generated based on a first data analysis of the historical claim data; and
obtaining the settlement estimate comprises generating, by the first computing device, the settlement estimate by inputting one or more claim attributes of the vehicle insurance claim into the first model or into another model generated based on another data analysis of the historical claim data to obtain the settlement estimate.

7. The method of claim 1, wherein obtaining the settlement estimate comprises receiving, by the first computing device, the settlement estimate from one of: a computing device corresponding to the insurance carrier, a computing device corresponding to the repair facility, or a user interface.

8. The method of claim 1, wherein providing the indication of the re-inspection score to the recipient computing device comprises providing the indication of the re-inspection score to a computing device corresponding to the insurance carrier.

9. The method of claim 1, wherein obtaining the settlement estimate comprises obtaining a settlement estimate generated at First Notice of Loss (FNOL).

10. The method of claim 1, further comprising determining, by the first computing device, an amount of a predicted financial profit or loss of a performance of the re-inspection of the vehicle insurance claim.

11. The method of claim 1, wherein at least a portion of the method is performed by a processor of the first computing device executing computer-executable instructions stored on a memory of the first computing device.

12. An apparatus for predicting re-inspection for a vehicle insurance claim, the apparatus comprising:
one or more tangible, non-transitory, computer-readable storage media storing thereon computer-executable instructions for generating a predictive re-inspection model, the computer-executable instructions executable by one or more processors to:
perform a predictive analysis on claim data corresponding to a plurality of historical vehicle insurance claims, the claim data including settlement estimates of the plurality of historical vehicle insurance claims, indications of whether or not re-inspections occurred for the plurality of historical vehicle insurance claims, and a plurality of claim attributes of the plurality of historical vehicle insurance claims; and
determine, based on the predictive analysis, a set of independent variables of the predictive re-inspection model, the set of independent variables comprising a subset of the plurality of claim attributes that are more strongly correlated to occurrences of re-inspections than are other attributes of the plurality of claim attributes;
generate the predictive re-inspection model based on the predictive analysis; and
determine, using the predictive re-inspection model, a re-inspection score for a vehicle insurance claim corresponding to a vehicle covered by an insurance policy provided by an insurance carrier, the re-inspection score based on a settlement estimate of the vehicle insurance claim,
wherein the settlement estimate is based on a previous inspection of the vehicle, and the re-inspection score is indicative of a probability of an occurrence of a re-inspection of the vehicle insurance claim and is for use in determining whether or not a re-inspection of the vehicle is warranted.

13. The apparatus of claim 12, wherein the settlement estimate of the vehicle insurance claim is an input into the predictive re-inspection model.

14. The apparatus of claim 12, further comprising additional computer-executable instructions stored on the one or more tangible, non-transitory, computer-readable storage media and executable by the one or more processors to predict a supplement amount corresponding to additional costs that are predicted to be identified from the re-inspection of the vehicle insurance claim.

15. The apparatus of claim 12, wherein the predicted supplement amount is an output of the predictive re-inspection model or is an output of a predictive supplement model generated based on another predictive analysis of the claim data corresponding to the plurality of historical vehicle claims.

16. The apparatus of claim 12, wherein the claim data further includes indications of respective levels of repair quality corresponding to the plurality of historical vehicle insurance claims, and wherein determining the re-inspection score is further based on a target level of repair quality for the vehicle.

17. The apparatus of claim 12, wherein the claim data corresponds to a plurality of insurance carriers.

18. The apparatus of claim 12, further comprising additional computer-executable instructions stored on the one or more tangible , non-transitory, computer-readable storage media and executable by the one or more processors to obtain the settlement estimate, wherein the settlement estimate is obtained by one of:
receiving the settlement estimate from a computing device corresponding to the insurance carrier;
receiving the settlement estimate from a computing device corresponding to a repair facility;
receiving the settlement estimate from a user interface; or
generating, by using the predictive re-inspection model generated based on the predictive analysis of the claim data or by using a predictive settlement model generated from another predictive analysis of the claim data, the settlement estimate based on at least a portion of the plurality of claim attributes of the vehicle insurance claim.

19. The apparatus of claim 12, wherein the previous inspection of the vehicle is associated with a First Notice of Loss (FNOL) of the vehicle insurance claim.

20. A method of identifying vehicle insurance claims for re-inspection, the method comprising:
obtaining, at a computing device, a set of re-inspection scores respectively corresponding to a set of vehicle insurance claims, wherein the re-inspection scores are determined by providing settlement estimates of the set of vehicle insurance claims to a predictive re-inspection model, the predictive re-inspection model is generated from a predictive analysis of historical vehicle claim data, and each of the re-inspection scores is indicative of a probability of an occurrence of a re-inspection of a respective vehicle insurance claim;
ranking, by the computing device, members of the set of vehicle insurance claims based on the set of re-inspection scores;
identifying, by the computing device, a subset of the set of vehicle insurance claims for re-inspection based on the rankings and on a re-inspection threshold; and
providing an indication of the subset of the set of vehicle insurance claims to at least one of a user interface or another computing device.

21. The method of claim 20, wherein obtaining the set of re-inspection scores corresponding to the set of vehicle insurance claims comprises obtaining the set of re-inspection scores corresponding to a set of vehicle insurance claims being serviced by a particular repair facility.

22. The method of claim 20, wherein the historical vehicle claim data is obtained from a plurality of insurance carriers.

23. The method of claim 20, wherein ranking the members of set of vehicle insurance claims comprises ranking the members based on respective differences between respective re-inspection scores and respective settlement estimates.

24. The method of claim 20, further comprising adjusting the re-inspection threshold.

25. The method of claim 20, wherein identifying the subset of the set of vehicle insurance claims based on the re-inspection threshold comprises identifying the subset of the set of vehicle insurance claims based on at least one of: a threshold level or a threshold percentage.

26. The method of claim 20, wherein providing the indication of the subset of the set of vehicle insurance claims to another computing device comprises providing the indication of the subset of the set of vehicle insurance claims to a computing device associated with an insurance carrier.
